(19) United States
(12) Patent Application Publication
(10) Pub. No.: US 2011/0036899 A1
(43) Pub. Date: Feb. 17, 2011

(54) MODULAR SOLDERING APPARATUS

(75) Inventor: Darren Harvey, Essex (GB)

Correspondence Address: DICKSTEIN SHAPIRO LLP, 1825 EYE STREET NW, Washington, DC, 20006-5403, US

(73) Assignee: PILLARHOUSE INTERNATIONAL LIMITED, Essex (GB)

(21) Appl. No.: 12/675,687

(22) PCT Filed: Aug. 28, 2008
(86) PCT No.: PCT/GB2008/002908

§ 371 Date: Oct. 21, 2010

(30) Foreign Application Priority Data
Aug. 28, 2007 (GB) 0716693.7

(51) Int. Cl. B23K 3/06; F04B 17/00

(52) U.S. Cl. 228/56.1; 417/321

(57) ABSTRACT

In a modular soldering apparatus a pump assembly (4) comprising a pump (67, 71) conduit 66 and solder nozzle (92) is removable as a unit and push contacts (42, 52′) which are broken by lifting the assembly are provided for the electrical, data and gas connections (80, 90). A solder bath (10) is also mounted on a support structure (16) and connected to data and power supplies (42) by push fit connections. The pump assembly and solder bath may be coupled together and removed as single unit.

The present invention relates to a modular soldering apparatus and in particular to a selective soldering apparatus in which the solder pump assembly and the solder bath are readily removable.

Selective soldering apparatus of the type described in our earlier applications such as U.S. Pat. No. 4,651,916, EP-A-860229, EP-A-1222988, W02005/115669, W02005/116571, utilise a bath of molten solder. Solder is pumped though a nozzle and flows back into the bath. It is necessary to dismantle the solder bath assembly from time to time. Routine maintenance may require that the solder be replaced, pump bearings may need to be replaced, and nozzle arrangements replaced when changing between production runs.

Even small solder baths are of heavy construction and there can be considerable down time whilst waiting for a bath to cool and gaining sufficient access to the bath to remove it safely or to work on it in situ. The bath and pump assemblies need to be connected to electrical power supplies to heat the solder and drive the pump, electronic controls for monitoring and controlling solder temperature, solder level, pump speed, nitrogen gas supplies for providing an inert atmosphere, etc. Thus connecting and disconnecting the bath or pump assembly is a lengthy operation.

We have developed a system in which a solder bath is fitted with a plurality of electrical contacts, preferably on its underside, for supplying power and data. The contacts mate with contacts of a supporting structure on which the bath rests. A pump assembly comprising a drive motor, pump and solder nozzle are similarly provided with power and data contacts, preferably on an underside of the assembly, in the vicinity of the electric motor which is housed to one side of the solder bath in use. The pump assembly is bolted to the bath in use and so the complete unit, bath and pump assembly can also be removed as one. At least one half of each electrical or data contact is preferably spring loaded, preferably the contact on the supporting structure.

To ensure proper earthing, earth contacts are provided at each end of an array of connectors.

Guide pins may be provided for aligning the bath and/or pump assembly prior to any electrical connections being made, to reduce the risk of mis-mating and damage to the contacts. The guide pins may also provide an earth path to the supporting structure so ensure earthing at an early stage.

A thermocouple, which monitors the temperature of solder in the bath is housed in a sheath which will extend up into a pocket or recess in the bath wall. The end of the thermocouple may be exposed and the thermocouple spring loaded to ensure that the end of the thermocouple mates adequately with the bath wall.

Nitrogen supply may be provided by coupling gas pipes via a butt joint.

The invention will be further described by way of example with reference to the accompanying drawings, in which:

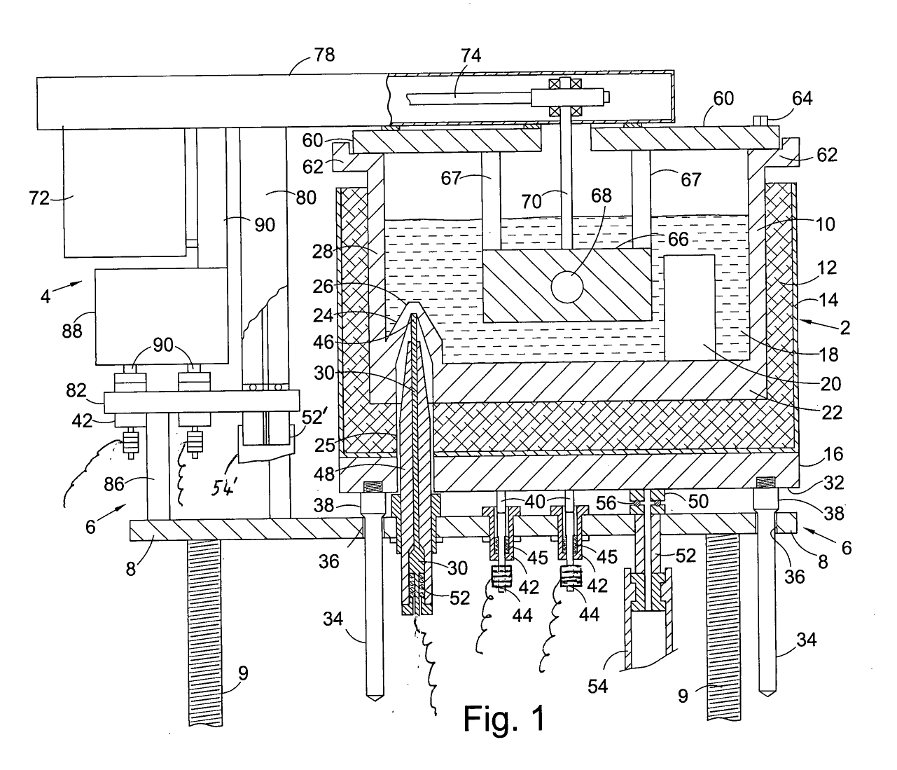

FIG. 1 is a schematic cross section though a modular solder bath and pump assembly of the invention mounted on a supporting structure;

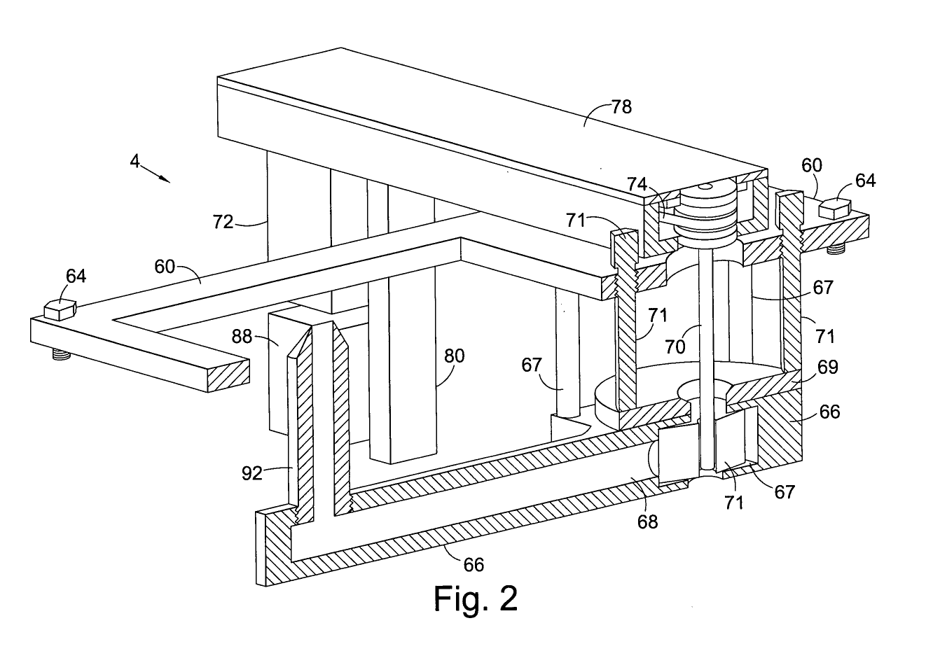

FIG. 2 illustrates schematically a pump assembly of the invention, and

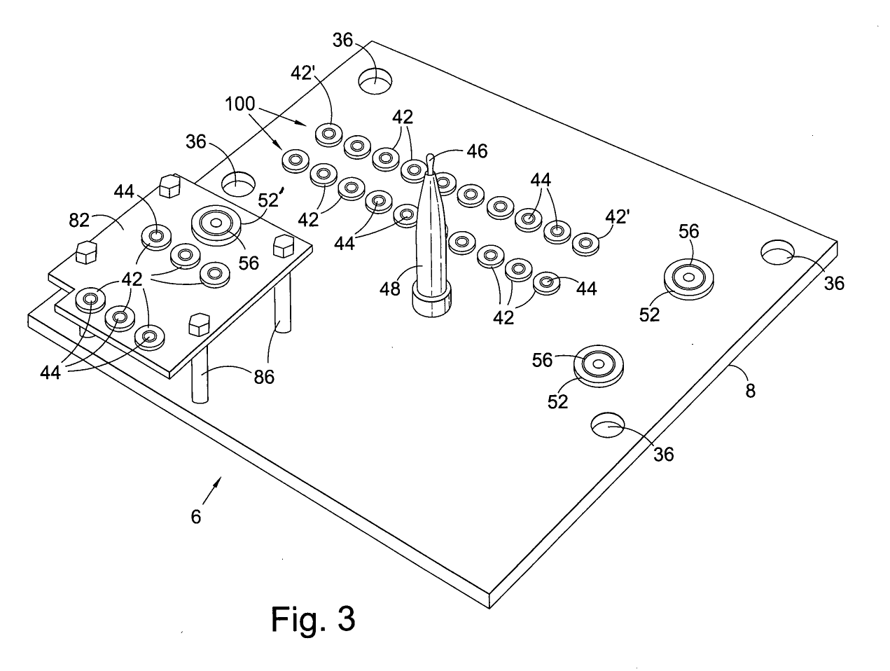

FIG. 3 illustrates the supporting structure for the pump assembly and bath.

Referring to FIG. 1 this shows a cross section through a solder bath 2 and pump assembly 4 mounted on a supporting structure 6.

Supporting structure 6 comprises a base plate 8 mounted on lead screws 9. Screws 9 are raised and lowered to adjust the height of the supporting structure 6 to adjust the height of the solder bath and pump assembly, in particular to adjust the height of the nozzle in the pump assembly, as well known in the art. In some systems the nozzle height is kept constant, in other systems the complete bath and pump assembly is raised. All such system are susceptible of using the modular approach of this invention.

The solder bath 2 comprises a metal pot 10 surrounded by insulation 12 and an outer jacket 14 on a base 16. Pot 10 contains molten solder 18 which is heated by electrical heaters 20. The base 22 of the pot 10 has a pocket 24 which projects upwards into the solder 18 to form a tip 26 spaced from the pot wall 28. Below pocket 24 a throughway 25 is formed in the base 16, outer casing 14 and insulation 10 to receive a thermocouple 30 which will be described hereinafter.

On the underside 32 of base 16, guide pins 34 are screwed into the base 6. Pins 34 pass though apertures 36 in the supporting structure base plate 8 to ensure the correct positioning of the bath 2 on the support base plate 8. A collar 38 formed on the pins 34 bears on the upper surface 40 of the base plate 6 to support the bath 2 and space it from the base plate 8.

To provide electrical and data connections to the bath 2, the bath 2 has a series of electrically conductive pins 40 mounted on the underside 32 of the base plate 16. Wiring (not shown) extends from the pins to the electrical components and transducers in the bath 2 as well known in the art and need not be described further here. With the bath positioned on the support base plate 8, each pin 40 is pushed into a respective socket 42 which carries an electrical contact 44 which is spring loaded, i.e. biased upwards by a spring 45, to form a mating connection. The end of the spring loaded contacts are threaded for connection of wires which feed to a power supply and processor based control unit (not shown). It will be appreciated that various forms of mating connector may be used, one contact being pushed into contact with the other to make an electrical connection.

Referring to the thermocouple 30, it is desirable that the tip 46 of the thermocouple be in physical contact with the pot 10 to ensure good thermal contact to measure the temperature of the solder in the bath. Thus the thermocouple needs to project up with in the bath, but such thermocouples are relatively delicate instruments. Thus, we house the thermocouple in a sheath 48 which extends up from the supporting base plate 8 and penetrates the aperture 25 through the base 16, jacket 14 and thermal insulation 10 to sit within the pocket 24 and bear on the inside surface of the pocket tip 26. The thermocouple itself is spring loaded upwards by a spring 52 to urge it against the pocket wall. The spring loading also allows the thermocouple to retract within the sheath in the event that it contacts the underside of the plate 16 when the bath is being lowered onto the support base plate 8.

Also seen in FIG. 1 is a connection 54 for nitrogen gas. Nitrogen is fed into the bath above the solder surface to provide a substantially oxygen free atmosphere. A tube 50 butts against an O-ring seal 56 of a union 52 mounted in the support base plate 8. Tube 50 may be biased down onto the O-ring.

The pump assembly 4 comprises support plate 60 which is bolted to a rim 62 of the solder pot 10 by bolts 64. This secures the pump assembly accurately in position relative to the bath assembly 2. Support plate 60 carries a conduit 66 which incorporates an impeller pump chamber 67 at one end of a passageway 68 and carries a nozzle 92 (not shown in FIG. 1) at the other end. Conduit 66 is held on legs 67 depending down from the support plate 60. A cap 69 is held on the top of the impeller chamber 67 by pins 71 screwed into the support plate 60.

Shown in FIG. 1 is a shaft 70 for driving the pump impeller 71. Shaft 70 is driven by an electric motor 72 via a pulley belt 74. A rigid housing 78 is secured to the support plate 60 and carries the electric motor 72. A contact box 88 depends down from the housing 78 via a tubular support 90.

A second supporting base plate 82 is secured on the support base plate 8 by legs 86. Second supporting base plate 82 carries sockets 42 with spring loaded contacts 44 for receiving contact pins 40 mounted on the underside of contact box 88. Wiring from the pins 40 extends into the box 88 and via conduit 90 to the electrical motor to feed power to the motor, for example.

Nitrogen is fed into the pulley belt housing 78 by a conduit 80, a nitrogen gas connection 52′ being provided on support plate 82 as well, and connected with a nitrogen supply tube 54′.

To decouple the pump assembly 4, the relevant data and electrical and gas supply lines to the support structure 6 are switched off. The bolts 64 are unscrewed from the bath 10 and the unit lifted upwards away from the bath 2 and second support base plate 82. Electrical and data contacts 40 simply lift out of the connectors 42 and the nitrogen supply tube 42 lifts away from the gas connection 54.

If desired, the solder bath 2 can then be lifted vertically upward away form the support base plate 8 after disconnecting the power and gas supplies to the connectors 42, 45. Electrical and data connections 40 lift out of connectors 42, the gas connection 50 lifts away. Pins 34 can be made sufficiently long to maintain alignment of the bath with the support plate 8 until the bath 2 clears the thermocouple 30 to avoid accidental damage to the thermocouple.

If desired the pump assembly 4 can be left bolted to the pot 10 and the combined bath and pump assemblies 2, 4 lifted away from the supporting structure 6 as a single unit.

Referring to FIG. 3, this shows the supporting structure 6. It is preferred that at least one contact 42′ at the end of the rows 100 be earthed to ensure that an earth connection remains in place if the bath is tilted whilst being raised

1. A soldering apparatus comprising a solder bath and a pump assembly mounted on a supporting structure, the pump assembly comprising an electric motor, an impeller pump driven by the electric motor, a conduit connecting a chamber of the impeller pump with a nozzle, and the nozzle, wherein the pump assembly is removable from the supporting structure as single unit and is connected to power supply contacts mounted on the supporting structure by mating connectors, the connection being broken as the pump assembly is lifted away.

2. Apparatus as claimed in claim 1, wherein the solder bath rests on the supporting structure and is connected to power supply contacts on the supporting structure by mating connectors.

3. Apparatus as claimed in claim 2, wherein the pump assembly and solder bath are coupled together and can be removed as a single unit.

4. Apparatus as claimed in claim 1, wherein mating connectors are provided on the supporting structure and the pump assembly and/or solder bath for feeding data to and from the pump assembly and/or solder bath.

5. Apparatus as claimed in claim 1, wherein a gas supply connection is provided between the supporting structure and the bath and/or pump assembly, the connection being a mating connection.

6. Apparatus as claimed in claim 1, wherein a thermocouple is mounted on the supporting structure and projects into a pocket in the solder bath when the bath is resting on the supporting structure.

7. A solder bath fitted with a plurality of electrical contacts, for supplying power and data, the contacts mating with contacts of a supporting structure on which the bath rests and contact being broken automatically when the bath is lifted from the supporting structure.

8. A pump assembly comprising a drive motor, pump and solder nozzle and provided with power contacts for supplying power to the drive motor, the contacts mating with contacts of a supporting structure on which the assembly is carried, and contact being broken automatically when the assembly is lifted from the supporting structure.

9. The pump assembly of claim 8 attached to a solder bath fitted with a plurality of electrical contacts, for supplying power and data, the contacts mating with contacts of a supporting structure on which the bath rests and contact being broken automatically when the bath is lifted from the supporting structure, so that the complete unit, bath and pump assembly, can lifted as one.

10. Apparatus as claimed in claim 1, wherein at least one half of an electrical or data contact is spring loaded.

11. Apparatus as claimed in claim 1, wherein guide pins are provided for aligning the bath and/or pump assembly prior to any electrical connections being made when lowering the bath or pump assembly onto the supporting structure.

12. Apparatus as claimed in claim 7, wherein a gas supply is provided on the supporting structure and gas is fed to the pump assembly or solder bath via a connection which is made automatically when the pump or solder bath is lowered onto the supporting structure and is broken automatically when the pump or solder bath is lifted away.
